(19) United States
(12) Patent Application Publication
(10) Pub. No.: US 2025/0238134 A1
(43) Pub. Date: Jul. 24, 2025

(54) Multiple Function Nonvolatile Memory Express (NVMe) Device (MFND) Performance Improvement By Over Reading

(71) Applicant: Western Digital Technologies, Inc., San Jose, CA (US)

(72) Inventors: Amir SEGEV, Meiter (IL); Shay BENISTY, Beer Sheva (IL)

(73) Assignee: Western Digital Technologies, Inc., San Jose, CA (US)

(21) Appl. No.: 18/419,013

(22) Filed: Jan. 22, 2024

(51) Int. Cl. G06F 3/06

(52) U.S. Cl. CPC G06F 3/061; G06F 3/0659; G06F 3/0679

(57) ABSTRACT

Instead of handling transaction layer packets (TLP) without over-read usage, utilize adaptive over-read. As TLPs are transferred from the host along the Peripheral Component Interconnect express (PCIe) in the fabric to the device, some performance options are best suited. The fabric prefers bytes read in multiples of 64 bytes, while the PCIe works best in smaller byte chunks. Adaptive over-read allows a device to periodically check a system through testing over-read usage to compare the results for best performance of the system. The system is checked periodically, because different devices in the system can have an effect on the fabric and PCIe that may change performance preferences.

### BACKGROUND OF THE DISCLOSURE

### Field of the Disclosure

Embodiments of the present disclosure generally relate to improving system performance through over-read usage.

### Description of the Related Art

When a device is performing a read or write, some of the Transaction Layer Packets (TLP) are not aligned. This can be because the original address was not aligned to 4K or the TLP size. Different components are configured to work in a different manner. An Advanced Extensible Interface (AXI) bus cannot read 12 bytes out of a 16 (or more) bytes wide bus. The bus has to break the total number of bytes into 8 bytes and 4 bytes transactions. The Peripheral Component Interconnect express (PCIe) bus adds overhead for every TLP, so breaking the 12 bytes means twice the amount of header. A switch might be optimized to work at 64 bytes chunks, and every smaller chunk will incur inefficiency. A Direct Memory Access (DMA) controller is optimized to work at 64 bytes alignment. In this case, due to the AXI limitation, the transfers will suffer from multiple inefficiencies.

Additionally, some of the inefficiencies appear not only when working with AXI, but even without AXI when the command data pointers or Physical Region Pages (PRP) are not aligned to 64. In previous approaches, the system suffers from these inefficiencies. Generally speaking, the device issues more PCIe packets in unaligned scenarios (e.g. when metadata is in place) to support host protocol and internal buses. This behavior leads to performance degradation.

Therefore, there is a need in the art for improving over-read usage through system checks for specific system needs.

### SUMMARY OF THE DISCLOSURE

Instead of handling transaction layer packets (TLP) without over-read usage, utilize adaptive over-read. As TLPs are transferred from the host along the Peripheral Component Interconnect express (PCIe) in the fabric to the device, some performance options are best suited. The fabric prefers bytes read in multiples of 64 bytes, while the PCIe works best in smaller byte chunks. Adaptive over-read allows a device to periodically check a system through testing over-read usage to compare the results for best performance of the system. The system is checked periodically, because different devices in the system can have an effect on the fabric and PCIe that may change performance preferences.

In one embodiment, a data storage device comprises: a memory device; and a controller coupled to the memory device, wherein the controller is configured to: receive a write command to write data to the memory device; execute the write command, wherein executing the write command comprises reading more data from a host device than corresponds to the write command; discard the more data; and deliver data corresponding to the write command to the memory device.

In another embodiment, a data storage device comprises: a memory device; and a controller coupled to the memory device, wherein the controller is configured to: determine whether execution of a write command would be an aligned read transfer; determine whether execution of the aligned read transfer is a non host memory buffer (HMB) and has an unsupported request (UR) bit; and determine an age of a last measurement of a range of data for the aligned read transfer.

In another embodiment, a data storage device comprises: means to store data; and a controller coupled to the means to store data, wherein the controller is configured to: operate in a multiple function nonvolatile memory express (NVMe) device (MFND) environment; determine that a first function of the MFND operates without metadata; determine that a second function of the MEND operates with aligned physical region page (PRPs); and perform over read operations for one or more of the first function and the second function.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic block diagram illustrating a storage system in which a data storage device may function as a storage device for a host device, according to certain embodiments.

FIG. 2 is a block diagram illustrating a system for a read request using AXI, according to one embodiment.

FIG. 3 is a block diagram illustrating a system for unaligned data, according to one embodiment.

FIG. 4A is a diagram illustrating a table without over-read, according to one embodiment.

FIG. 4B is a diagram illustrating a table showing the reads done utilizing simple over-read, according to one embodiment.

FIG. 4C is a diagram illustrating a table showing a TLP overhead, according to one embodiment.

FIG. 4D is a diagram illustrating a table showing the number of bytes used in each operation, according to one embodiment.

FIG. 5 is a flowchart illustrating a method for over-read usage, according to certain embodiments.

FIG. 6A is a diagram illustrating a table for an optimized simple read, according to one embodiment.

FIG. 6B is a diagram illustrating a table for comparing operations, according to one embodiment.

FIG. 7 is a flowchart illustrating a method for adaptive over-read, according to certain embodiments.

FIG. 8 is a diagram illustrating a table for tracking an operation decision, according to one embodiment.

FIG. 9 is a flowchart illustrating a method for operation usage, according to certain embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specifically described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments, and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Instead of handling transaction layer packets (TLP) without over-read usage, utilize adaptive over-read. As TLPs are transferred from the host along the Peripheral Component Interconnect express (PCIe) in the fabric to the device, some performance options are best suited. The fabric prefers bytes read in multiples of 64 bytes, while the PCIe works best in smaller byte chunks. Adaptive over-read allows a device to periodically check a system through testing over-read usage to compare the results for best performance of the system. The system is checked periodically, because different devices in the system can have an effect on the fabric and PCIe that may change performance preferences.

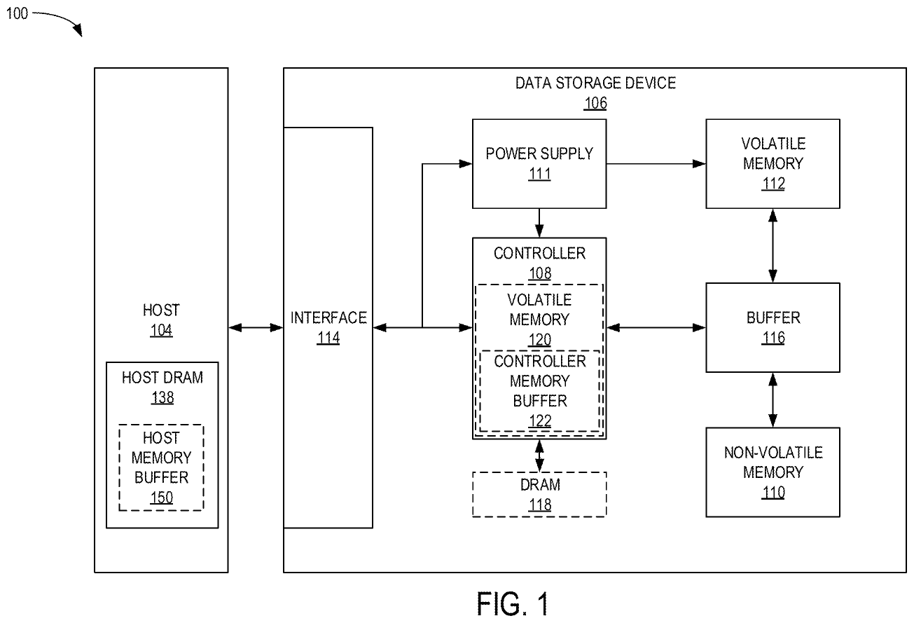

FIG. 1 is a schematic block diagram illustrating a storage system 100 having a data storage device 106 that may function as a storage device for a host device 104, according to certain embodiments. For instance, the host device 104 may utilize a non-volatile memory (NVM) 110 included in data storage device 106 to store and retrieve data. The host device 104 comprises a host dynamic random access memory (DRAM) 138. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1, the host device 104 may communicate with the data storage device 106 via an interface 114. The host device 104 may comprise any of a wide range of devices, including computer servers, network-attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The host DRAM 138 may optionally include a host memory buffer (HMB) 150. The HMB 150 is a portion of the host DRAM 138 that is allocated to the data storage device 106 for exclusive use by a controller 108 of the data storage device 106. For example, the controller 108 may store mapping data, buffered commands, logical to physical (L2P) tables, metadata, and the like in the HMB 150. In other words, the HMB 150 may be used by the controller 108 to store data that would normally be stored in a volatile memory 112, a buffer 116, an internal memory of the controller 108, such as static random access memory (SRAM), and the like. In examples where the data storage device 106 does not include a DRAM (i.e., optional DRAM 118), the controller 108 may utilize the HMB 150 as the DRAM of the data storage device 106.

The data storage device 106 includes the controller 108, NVM 110, a power supply 111, volatile memory 112, the interface 114, a write buffer 116, and an optional DRAM 118. In some examples, the data storage device 106 may include additional components not shown in FIG. 1 for the sake of clarity. For example, the data storage device 106 may include a printed circuit board (PCB) to which components of the data storage device 106 are mechanically attached and which includes electrically conductive traces that electrically interconnect components of the data storage device 106 or the like. In some examples, the physical dimensions and connector configurations of the data storage device 106 may conform to one or more standard form factors. Some example standard form factors include, but are not limited to, 3.5″ data storage device (e.g., an HDD or SSD), 2.5″ data storage device, 1.8″ data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered or plugged into a connector) to a motherboard of the host device 104.

Interface 114 may include one or both of a data bus for exchanging data with the host device 104 and a control bus for exchanging commands with the host device 104. Interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. Interface 114 (e.g., the data bus, the control bus, or both) is electrically connected to the controller 108, providing an electrical connection between the host device 104 and the controller 108, allowing data to be exchanged between the host device 104 and the controller 108. In some examples, the electrical connection of interface 114 may also permit the data storage device 106 to receive power from the host device 104. For example, as illustrated in FIG. 1, the power supply 111 may receive power from the host device 104 via interface 114.

The NVM 110 may include a plurality of memory devices or memory units. NVM 110 may be configured to store and/or retrieve data. For instance, a memory unit of NVM 110 may receive data and a message from controller 108 that instructs the memory unit to store the data. Similarly, the memory unit may receive a message from controller 108 that instructs the memory unit to retrieve data. In some examples, each of the memory units may be referred to as a die. In some examples, the NVM 110 may include a plurality of dies (i.e., a plurality of memory units). In some examples, each memory unit may be configured to store relatively large amounts of data (e.g., 128 MB, 256 MB, 512 MB, 1 GB, 2 GB, 4 GB, 8 GB, 16 GB, 32 GB, 64 GB, 128 GB, 256 GB, 512 GB, 1 TB, etc.).

In some examples, each memory unit may include any type of non-volatile memory devices, such as flash memory devices, phase-change memory (PCM) devices, resistive random-access memory (ReRAM) devices, magneto-resistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR-based flash memory devices and may store data based on a charge contained in a floating gate of a transistor for each flash memory cell. In NVM flash memory devices, the flash memory device may be divided into a plurality of dies, where each die of the plurality of dies includes a plurality of physical or logical blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The power supply 111 may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, super-capacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The volatile memory 112 may be used by controller 108 to store information. Volatile memory 112 may include one or more volatile memory devices. In some examples, controller 108 may use volatile memory 112 as a cache. For instance, controller 108 may store cached information in volatile memory 112 until the cached information is written to the NVM 110. As illustrated in FIG. 1, volatile memory 112 may consume power received from the power supply 111. Examples of volatile memory 112 include, but are not limited to, random-access memory (RAM), dynamic random access memory (DRAM), static RAM (SRAM), and synchronous dynamic RAM (SDRAM (e.g., DDR1, DDR2, DDR3, DDR3L, LPDDR3, DDR4, LPDDR4, and the like)). Likewise, the optional DRAM 118 may be utilized to store mapping data, buffered commands, logical to physical (L2P) tables, metadata, cached data, and the like in the optional DRAM 118. In some examples, the data storage device 106 does not include the optional DRAM 118, such that the data storage device 106 is DRAM-less. In other examples, the data storage device 106 includes the optional DRAM 118.

Controller 108 may manage one or more operations of the data storage device 106. For instance, controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. Controller 108 may determine at least one operational characteristic of the storage system 100 and store at least one operational characteristic in the NVM 110. In some embodiments, when the data storage device 106 receives a write command from the host device 104, the controller 108 temporarily stores the data associated with the write command in the internal memory or write buffer 116 before sending the data to the NVM 110.

The controller 108 may include an optional second volatile memory 120. The optional second volatile memory 120 may be similar to the volatile memory 112. For example, the optional second volatile memory 120 may be SRAM. The controller 108 may allocate a portion of the optional second volatile memory to the host device 104 as controller memory buffer (CMB) 122. The CMB 122 may be accessed directly by the host device 104. For example, rather than maintaining one or more submission queues in the host device 104, the host device 104 may utilize the CMB 122 to store the one or more submission queues normally maintained in the host device 104. In other words, the host device 104 may generate commands and store the generated commands, with or without the associated data, in the CMB 122, where the controller 108 accesses the CMB 122 in order to retrieve the stored generated commands and/or associated data.

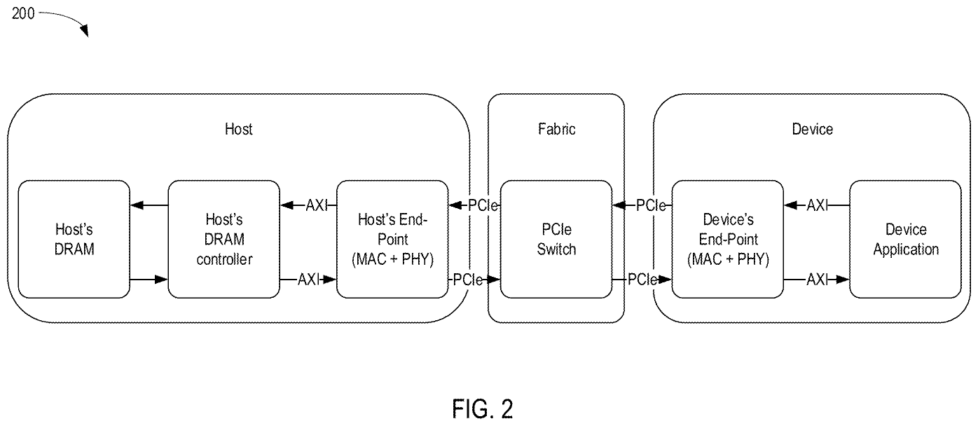

FIG. 2 is a block diagram illustrating a system 200 for a read request using AXI, according to one embodiment. In a Non-Volatile Memory express (NVMe) over PCIe, a storage device acts as a bus master. As part of the protocol, the device issues read commands from host. Those reads traverse through the fabric until the reads reach their destination (in the root complex) and the response traverse back.

The device application initiates a read request (using AXI) which goes through the device endpoint that translates the read request to TLP (PCIe format). The request goes through the PCIe switch and arrives at the host. Inside the host (root complex), the transfer is directed (again using AXI) to the host DRAM controller, which fetches the needed data from the host DRAM. The data then traverses in the opposite direction back to the device application.

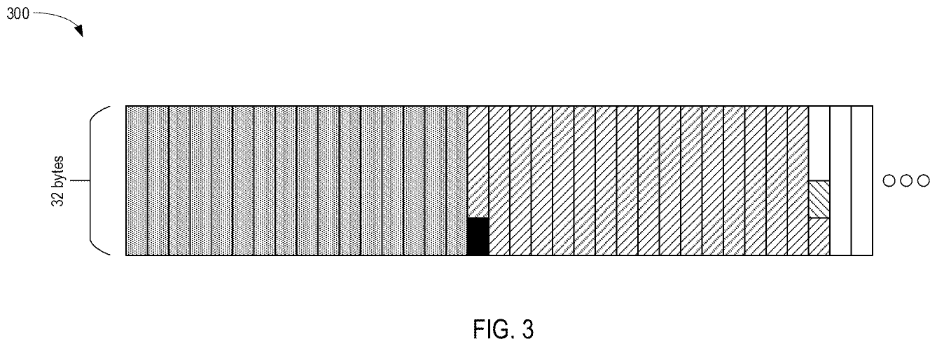

FIG. 3 is a block diagram illustrating a system 300 for unaligned data, according to one embodiment. The system 300 shows how the data is arranged in a host side memory range. The data is formatted with NVMe metadata of 8 bytes per Logical Block Address (LBA), using Data Interchange Format (DIF). System 300 depicts 32 bytes per memory line, but other widths might be used. The first sector (512 bytes) shown in shaded grey contains 16 full lines, followed by 8 bytes of metadata (black).

The second sector (shaded grey stripes) starts immediately after, so the first 24 bytes are concatenated with the 8 metadata bytes of the first sector, then 16 full lines of 32 bytes each, and finally 8 bytes of data, and 8 more of metadata (black stripes). This causes un-alignment in the memory in regards to a single LBA. The same example can be given for an LBA of 4K, or for metadata of other sizes, or simply for an unaligned PRP (protocol utilizes dword/4-bytes alignment only) or even a Scatter Gather List (SGL) that might be byte aligned.

As will be discussed herein, the disclosure proposes that the storage device controller will be allowed to utilize over-reading to achieve better performance. Over-reading means that the device will read X (e.g., 64, 128 or 256) bytes even when it requires less and will drop the un-needed data internally. The value of X depends on the amount of data needed to be read from the host DRAM. The value of X is calibrated on the fly to maximize performance.

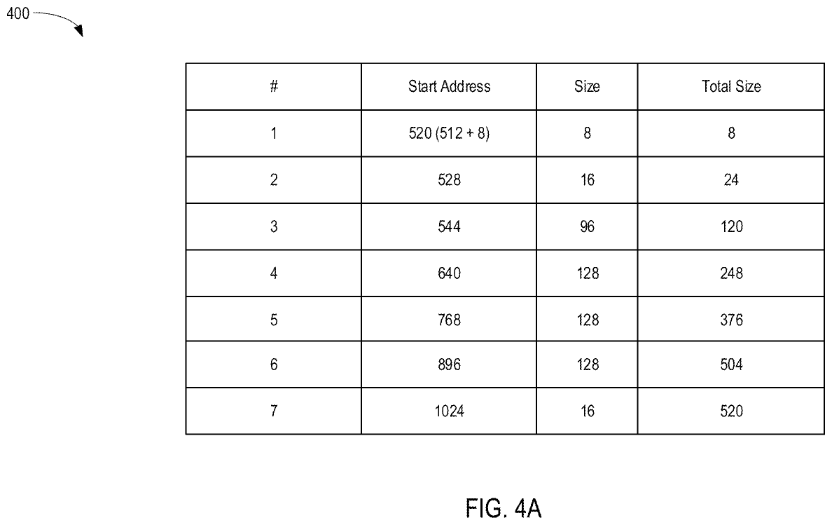

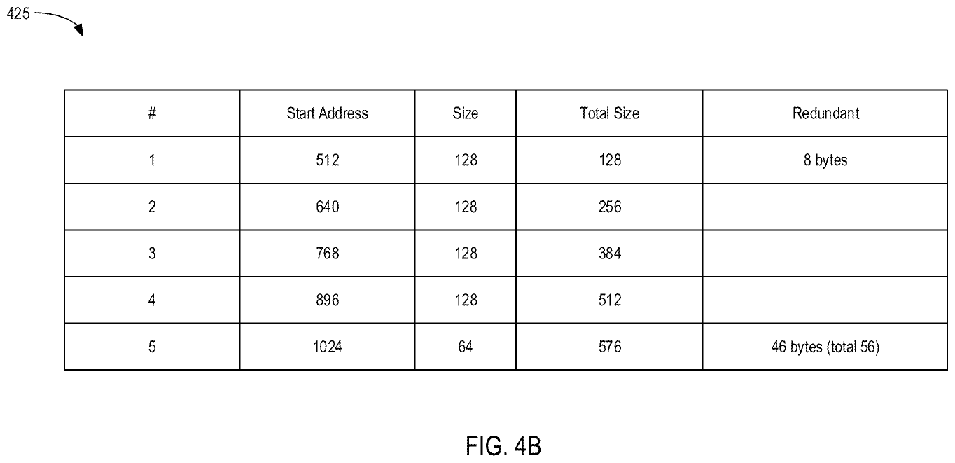

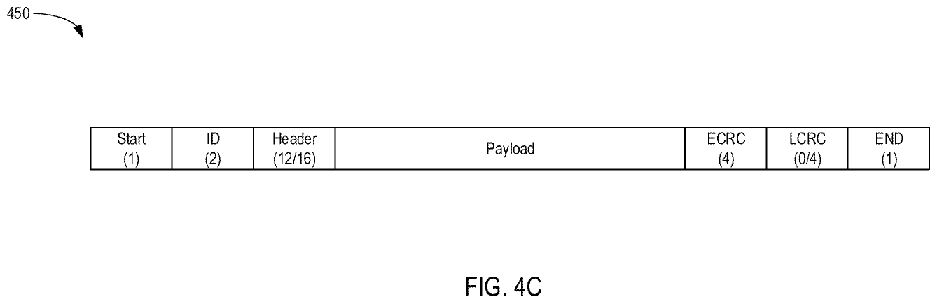

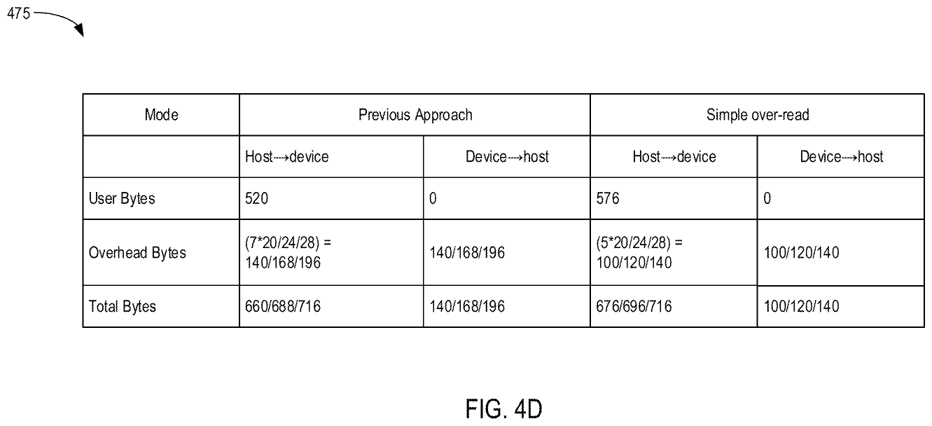

FIG. 4A is a diagram illustrating a table 400 without over-read, according to one embodiment. Simple over-read defined here is where the device uses only internally known information to decide on a course of action. Looking at the table 400, if the device needs to read only the second sector (from FIG. 3) this is how the device will proceed (with TLP limited at 128 bytes). The whole command is aligned to 4K, so the second sector starts at 512+8 bytes. The “size” column of table 400 is the size of the TLP that the device will issue. There are 7 TLPs used each of different sizes.

FIG. 4B is a diagram illustrating a table 425 showing the reads done utilizing simple over-read, according to one embodiment. With “simple over-read” the following reads will be done. The TLPs 1-7 of FIG. 4A are combined together as followed. TLP 1, 2, and 3 will be read together as 128 bytes in new TLP 1. TLP 4 will be read as 128 bytes in new TLP 2. TLP 5 will be read as 128 bytes in new TLP 3. TLP 6 will be read as the 128 bytes in new TLP 4. TLP 7 will be read as 64 bytes in new TLP 5. New TLPs 1-4 of will all have a size of 128 bytes using the simple over read method. New TLP 5 will have a size of 64 bytes. New TLP 1 reads 8 extra bytes, while New TLP 5 reads 46 extra bytes with a total of 56 bytes extra being read across the New TLPs. New TLP 5 reads 64 bytes because the fabric, as seen in FIG. 2, prefers to read in multiples of 64 bytes.

Over-reading means that the device will read X (e.g. X=64, 128 or 256) bytes even when the system requires less and will drop the un-needed data internally. The value of X depends on the amount of data needed to be read from Host DRAM. The value of X is calibrated “on-the-fly” to maximize the performance

FIG. 4C is a diagram illustrating a table 450 showing a TLP overhead, according to one embodiment. The header can be either 12 bytes or 16 bytes and Link Command and Response Channel (LCRC) can either exist or not exist. The option of using Error Correction and Reporting Channel (ECRC) is available as well. There are three different options for payload size. The total size is to be 20 bytes, 24 bytes or 28 bytes. Again, depending on the configuration, but those are the options and for an Embedded Systems Software (ESS) device the payload size will be at least 24.

FIG. 4D is a diagram illustrating a table 475 showing the number of bytes used in each operation, according to one embodiment. As an example to see how many bytes is needed to pass 520 bytes, the 520 bytes would be the user data as seen in FIG. 4A (total size column). In this case for the 520 bytes, to calculate the overhead bytes in the previous approach (no over-read) the device will run the operation (7*20/24/28). Using the 24 for this example, from the host to device path the overhead bytes is 168 bytes. Using the simple over-read approach the device will need 56 more bytes of user data starting out. From the device to host path using the same 24 for calculations. The device utilizes 48 less bytes using the simple over-read operation opposed to the previous approach. In the case of 28 bytes, the value is the same from the device to host path and the host to device path in both the previous approach and the simple over-read approach. The advantage is shown in the device to host path because to issue 7 read commands in this example using 24, 168 bytes is needed in the previous approach opposed to the 120 bytes need in the simple over-read approach.

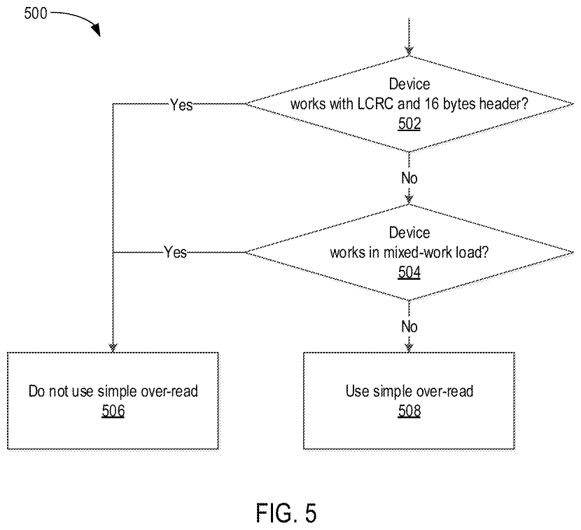

FIG. 5 is a flowchart illustrating a method 500 for over-read usage, according to certain embodiments. Disregarding other components efficiency, the method 500 suggests when to use over-read. Using the calculations from FIG. 4D, the method 500 can decide on simple over-read usage.

The method 500 begins at block 502. At block 502, the controller determines whether the device works with LCRC and 16 bytes header. The device will look at the LCRC and header size to determine whether bytes will be saved with use of the simple over-read approach. If the controller determines that the device does work with LCRC and the 16 byte header, then the method 500 proceeds to block 506. At block 506, the device does not use simple over-read. If the controller determines that the device does not work with LCRC and the 16 byte header, then the method 500 proceeds to block 504. At block 504, the controller determines whether the device works in mixed-work load.

The device will look at mixed-workloads because with only write commands the added bandwidth is acceptable for performance. When a mixed-work load utilizes both a read and write command, the device has bandwidth gains from saving in the device to host path. With read commands the device sends data to the host. In this example write commands are being discussed. If a bigger amount of data is needed to be passed saving the bandwidth when available, then that is best for the device. If the controller determines that the device does work in mix-work load, then the method 500 proceeds to block 506. If the controller determines that the device does not work in mixed-work load, then the method 500 proceeds to block 508. At block 508, the device does use simple over-read.

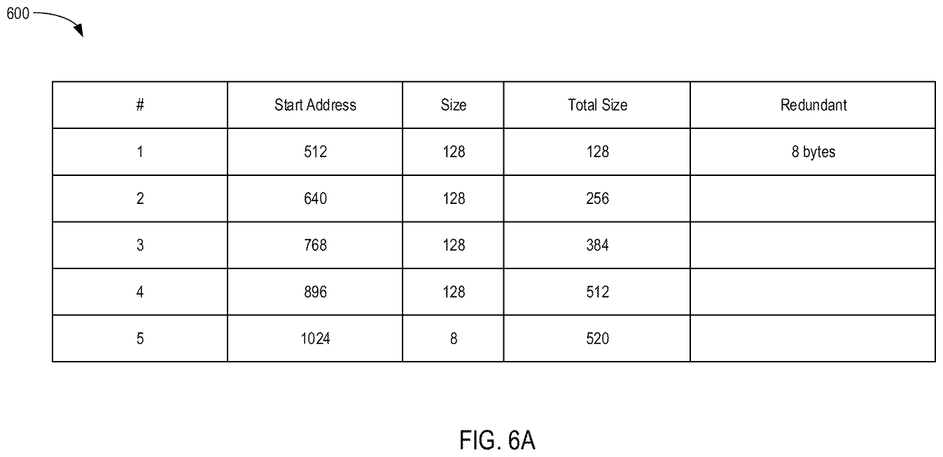

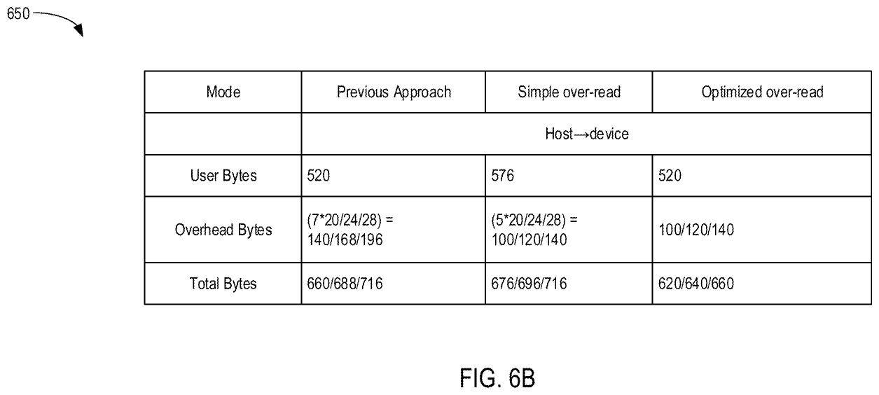

FIG. 6A is a diagram illustrating a table 600 for an optimized over-read, according to one embodiment. Optimization will be used, but not always because in not all case does the user want to only look at what is beneficial for the PCIe. In some cases the user want to sometimes save bandwidth even if saving bandwidth is harder for the fabric. With “optimized over-read” the following reads will be done. The TLPs 1-7 of FIG. 4A are combined together as followed. TLP 1, 2, and 3 will be read together as 128 bytes at new TLP 1. TLP 4 will be read as 128 bytes as new TLP 2. TLP 5 will be read as 128 bytes as new TLP 3. TLP 6 will be read as 128 bytes as new TLP 4. TLP 7 will be read as 8 bytes as new TLP 5. New TLPs 1-4 of will all have a size of 128 bytes using the simple over read method. New TLP 5 will have a size of 8 bytes. New TLP 1 reads 8 extra bytes. In this case, even though the fabric prefers to read in multiple of 64 bytes, the device has decided to disregard the preference of the fabric. Two transactions are saved in this case so the device didn't take a loss.

FIG. 6B is a diagram illustrating a table 650 for comparing operations, according to one embodiment. The table 650 clearly shows that optimized over-read utilizes less bandwidth on the host to device path even in the low overhead case.

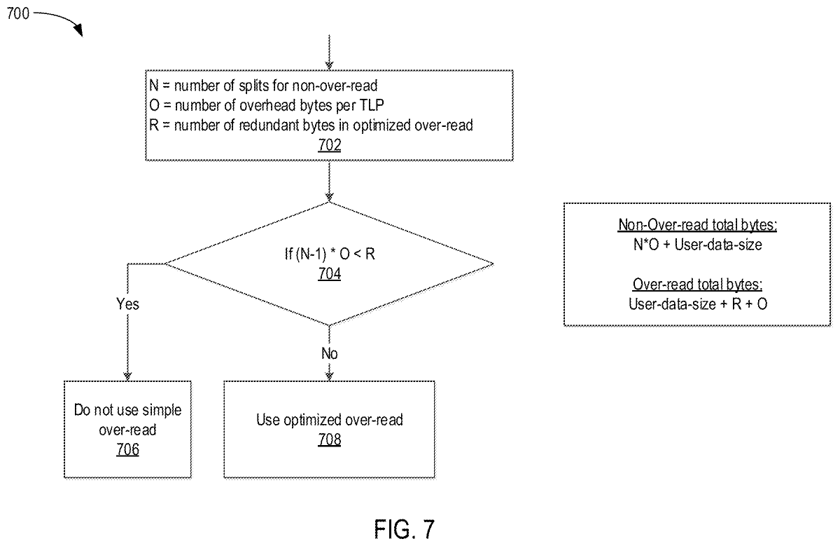

FIG. 7 is a flowchart illustrating a method 700 for optimized over-read, according to certain embodiments. In the optimized over-read, each potential simple-over-read TLP is compared to its equivalent no over-read option. The extra (non-user data) byte in each method is checked. In the simple over read, the extra is TLP size minus user data. In the no over-read option, the extra is the number of splits multiplied by the TLP overhead. The calculation needs to take into consideration that even in the over-read method there is one TLP overhead. If the “extra” bytes of simple-over read is more than the “extra” bytes of no-over-read, than no over-read approach will be taken. However, if the “extra” bytes of the simple over-read is equal or less than those of the no-over-read, the over-read approach will be used.

The adaptive over-read takes into consideration also external consideration, such as efficiency and requirements in the host and switches. In method 700, the device attempts all three modes: “no-over-read”, “simple-over-read”, and “optimized over-read”, and measures the latency. This test can be repeated periodically as workload might change over-time. The method 700 begins at block 702. At block 702, N=number of splits for non-over-read, O=number of overhead bytes per TLP, R=number of redundant bytes in optimized over-read. At block 704, the controller determines whether if (N−1)*O<R. If the controller determines that (N−1)*O<R, then the method 700 proceeds to block 706. At block 706, the controller does not use simple over-read. If the controller determines that (N−1)*O>R, then the method 700 proceeds to block 708. At block 708, the controller uses optimized over-read. Non-over-read total bytes is N*O+user-data-size. Over-read total bytes is user-data-size+R+O.

According to one embodiment an adaptive over-read approach can be used. The device will check the previous approach (no over-read), simple over-read, and optimized over-read to see which is best for the device. The device will be checked every once in a while in a predetermined time defined by the device to make the check. The check consists of measuring the latency of each operation, to then provide which operation gives the best results. The repeating of the check every predetermined time is done because when the traffic loads changes, there can be changes in other devices in the system that may affect the fabric behavior or the host behavior.

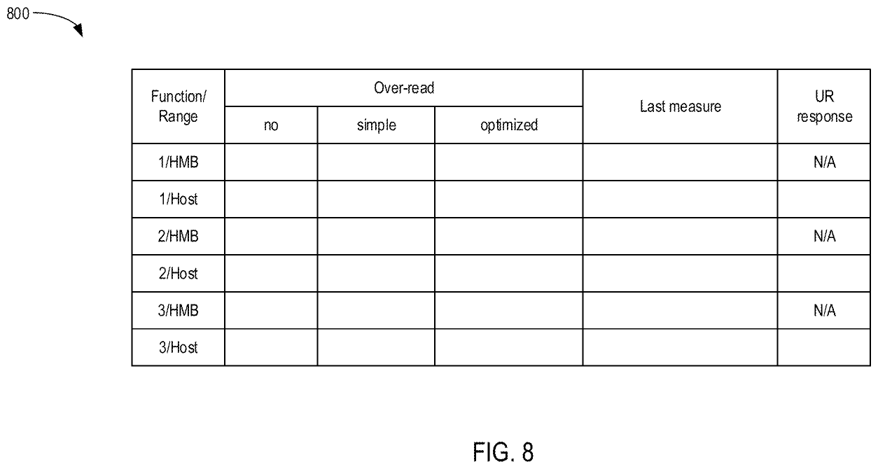

FIG. 8 is a diagram illustrating a table 800 for tracking an operation decision, according to one embodiment. In an MFND environment, multiple virtual hosts might hold different requirements. One function might work without metadata, and only with aligned PRPs, while another function might work with metadata. One function might have HMB range, and another might not. One function might have strict security policies, and another might be more relaxed. A strict policy function might enforce that the device reads only the data the device was requested to read. When strict secured policy is used, the function will return an unsupported request (UR) to an over-read. The device will track this response per-function and will disable over-read for these functions. For the HMB range in specific, the controller is allowed free access, so even when the controller returns a UR, the device can still use over-reads.

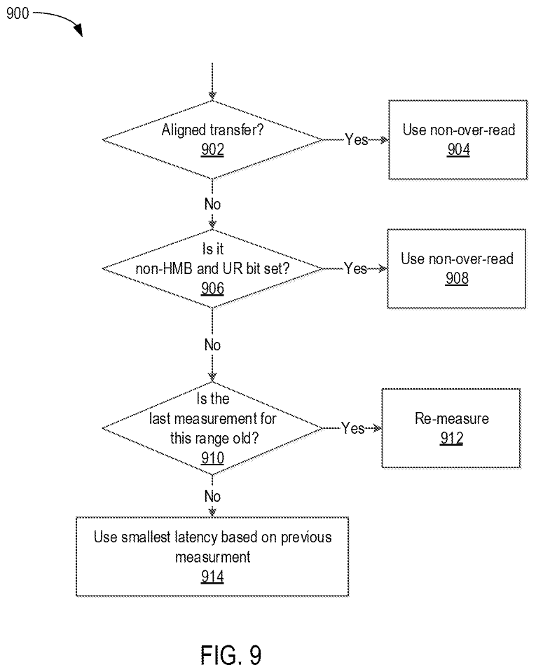

FIG. 9 is a flowchart illustrating a method 900 for operation usage, according to certain embodiments. The method 900 begins at block 902. At block 902, the controller determines whether the transfer is aligned. If the controller determines that the transfer is aligned, then the method 900 proceeds to block 904. At block 904, the controller uses non-over-read. If the controller determines that the transfer is not aligned, then the method 900 proceeds to block 906. At block 906, the controller determines whether the transfer is non-HMB and UR bits set. If the controller determines that the transfer is non-HMB and UR bit set, then the method 900 proceeds to block 908. At block 908, the controller use non-over-read. If the controller determines that the transfer is not non-HMB and UR bit set, then the method 900 proceeds to block 910.

At block 910, the controller determines whether the last measurement for this range is old. The “range” is per function. In another embodiment, a range can be HMB and non-HMB, but can further be HMB, PRP, commands fetching, or data transfer. The “old” is in reference to if the last statement was done more some configurable threshold. When doing a measurement for the first time, or doing a re-measure, the time of the measurement is kept in the table, such as table 800 of FIG. 8, as well as the result of the measurement. If the controller determines that the last measurement for this range is old, then the method 900 proceeds to block 912. At block 912, the controller re-measures. If the controller determines that the last measurement for this range is not old, then the method 900 proceeds to block 914. At block 914, the controller uses the smallest latency based on previous measurement. The previous measurement refers to the best option on table 800 of FIG. 8.

By testing three different read methods of unaligned data, and by managing a per function UR responses, the data storage device can optimize both HMB access and non-HMB access to achieve better performance. Using the new approach allows the device to utilize a customize approach to over-read usage that will increase optimization of the system, which will then increase performance.

In one embodiment, a data storage device comprises: a memory device; and a controller coupled to the memory device, wherein the controller is configured to: receive a write command to write data to the memory device; execute the write command, wherein executing the write command comprises reading more data from a host device than corresponds to the write command; discard the more data; and deliver data corresponding to the write command to the memory device. An amount of data corresponding to the write command is less than an aligned data size. The amount of data corresponding to the write command and the discarded more data collectively is equal to the aligned data size. The controller is configured to determine whether to perform a simplified over read or an optimized over read. The determining is performed by calculating whether (N−1)*O<R where N is a number of splits for non over reads, O is a number of overhead bytes per transaction layer packet (TLP), and R is a number of redundant bytes in the optimized over read. The optimized over read is performed when R> (N−1)*O. The controller is configured to perform an adaptive over read. The adapted over read is a periodic measuring of latency for not over reading, simplified over reading, and optimized over reading. The controller is configured to operate in a multiple function nonvolatile memory express (NVME) device (MFND) environment. At least one virtual host in the MFND environment has different requirements from at least one other virtual host. The at least one virtual host uses a different over read than the at least one other virtual host. The controller is further configured to detect an unsupported request notification from a host device, and wherein the controller is configured to continue to perform over reads.

In another embodiment, a data storage device comprises: a memory device; and a controller coupled to the memory device, wherein the controller is configured to: determine whether execution of a write command would be an aligned read transfer; determine whether execution of the aligned read transfer is a non host memory buffer (HMB) and has an unsupported request (UR) bit; and determine an age of a last measurement of a range of data for the aligned read transfer. The controller is configured to over read data when determining that execution of the aligned read transfer would result in a non-aligned transfer. The range is per function. The age is determined by comparing a time of a last measurement to a threshold. The range is applicable to HMB, command fetching, data transfer, and physical region page (PRP).

In another embodiment, a data storage device comprises: means to store data; and a controller coupled to the means to store data, wherein the controller is configured to: operate in a multiple function nonvolatile memory express (NVMe) device (MFND) environment; determine that a first function of the MFND operates without metadata; determine that a second function of the MEND operates with aligned physical region page (PRPs); and perform over read operations for one or more of the first function and the second function. The controller is configured to return an unsupported request (UR) notification to a host device to a function of the MEND that only supports aligned reads and a read operation resulted in an over read. The controller is configured to disable over read for functions of the MEND that receive a UR notification.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
a memory device; and
a controller coupled to the memory device, wherein the controller is configured to:
receive a write command to write data to the memory device;
execute the write command, wherein executing the write command comprises reading more data from a host device than corresponds to the write command;
discard the more data; and
deliver data corresponding to the write command to the memory device.

2. The data storage device of claim 1, wherein an amount of data corresponding to the write command is less than an aligned data size.

3. The data storage device of claim 2, wherein the amount of data corresponding to the write command and the discarded more data collectively is equal to the aligned data size.

4. The data storage device of claim 1, wherein the controller is configured to determine whether to perform a simplified over read or an optimized over read.

5. The data storage device of claim 4, wherein the determining is performed by calculating whether (N−1)*O<R where N is a number of splits for non over reads, O is a number of overhead bytes per transaction layer packet (TLP), and R is a number of redundant bytes in the optimized over read.

6. The data storage device of claim 5, wherein the optimized over read is performed when R>(N−1)*O.

7. The data storage device of claim 1, wherein the controller is configured to perform an adaptive over read.

8. The data storage device of claim 7, wherein the adapted over read is a periodic measuring of latency for not over reading, simplified over reading, and optimized over reading.

9. The data storage device of claim 1, wherein the controller is configured to operate in a multiple function nonvolatile memory express (NVMe) device (MFND) environment.

10. The data storage device of claim 9, wherein at least one virtual host in the MFND environment has different requirements from at least one other virtual host.

11. The data storage device of claim 10, wherein the at least one virtual host uses a different over read than the at least one other virtual host.

12. The data storage device of claim 1, wherein the controller is further configured to detect an unsupported request notification from a host device, and wherein the controller is configured to continue to perform over reads.

13. A data storage device, comprising:
a memory device; and
a controller coupled to the memory device, wherein the controller is configured to:
determine whether execution of a write command would be an aligned read transfer;
determine whether execution of the aligned read transfer is a non host memory buffer (HMB) and has an unsupported request (UR) bit; and
determine an age of a last measurement of a range of data for the aligned read transfer.

14. The data storage device of claim 13, wherein the controller is configured to over read data when determining that execution of the read command would result in a non-aligned transfer.

15. The data storage device of claim 13, wherein the range is per function.

16. The data storage device of claim 13, wherein the age is determined by comparing a time of a last measurement to a threshold.

17. The data storage device of claim 13, wherein the range is applicable to HMB, command fetching, data transfer, and physical region page (PRP).

18. A data storage device, comprising:
means to store data; and
a controller coupled to the means to store data, wherein the controller is configured to:
operate in a multiple function nonvolatile memory express (NVMe) device (MFND) environment;
determine that a first function of the MEND operates without metadata;
determine that a second function of the MEND operates with aligned physical region page (PRPs); and
perform over read operations for one or more of the first function and the second function.

19. The data storage device of claim 18, wherein the controller is configured to return an unsupported request (UR) notification to a host device to a function of the MEND that only supports aligned reads and a read operation resulted in an over read.

20. The data storage device of claim 19, wherein the controller is configured to disable over read for functions of the MEND that receive a UR notification.
